(19) United States
(12) Patent Application Publication
(10) Pub. No.: US 2019/0004278 A1
(43) Pub. Date: Jan. 3, 2019

(54) IMAGING LENS AND IMAGING APPARATUS

(71) Applicant: Sony Corporation, Tokyo (JP)

(72) Inventor: Masaharu Hosoi, Kanagawa (JP)

(21) Appl. No.: 16/069,615

(22) PCT Filed: Dec. 15, 2016
(86) PCT No.: PCT/JP2016/087415

§ 371 Date: Jul. 12, 2018

(30) Foreign Application Priority Data
Feb. 12, 2016 (JP) 2016-024597

(51) Int. Cl. G02B 7/04; G02B 9/64; G02B 13/18

(52) U.S. Cl. CPC G02B 7/04; G02B 13/18; G02B 9/64

(57) ABSTRACT

An imaging lens of the present disclosure includes: a first lens group having positive refractive power; a second lens group having negative refractive power; and a third lens group having positive refractive power, the first lens group, the second lens group, and the third lens group being provided in order from an object side to an image plane side, in which only the second lens group travels in an optical axis direction upon focusing, and the second lens group includes a negative lens and a positive lens in order from the object side to the image plane side with an air spacing in between, and satisfies the following conditional expression,

1.75<nn<2.20 (1)
where nn is a refractive index, at d-line, of the negative lens in the second lens group.

### TECHNICAL FIELD

The present disclosure relates to an imaging lens suitable specifically for a large-aperture aging lens system of a lens-interchangeable digital camera system, and an imaging apparatus including such an imaging lens.

### BACKGROUND ART

In recent years, the number of pixels in an imaging device used for a lens-interchangeable digital camera system has been rapidly increased. In order to record a higher-definition image, in addition to an increase in the number of pixels in the imaging device, higher delineation performance of an imaging lens is demanded. Accordingly, an imaging lens that suppresses occurrence of aberrations more than before is demanded.

Moreover, users that use a lens-interchangeable digital camera system to shoot not only a still image but also a moving image have been increased. In shooting of a moving image, in order to continue focusing on a subject, it is necessary to allow a focus lens to travel at high speed. Accordingly, the imaging lens is also demanded to allow for high-speed focusing as an important factor.

### CITATION LIST

### Patent Literature

PTL 1: Japanese Unexamined Patent Application Publication No. 2013-257395

PTL 2: Japanese Unexamined Patent Application Publication No. 2002-55275

### SUMMARY OF THE INVENTION

PTLs 1 and 2 each propose an imaging lens that includes a positive first lens group, a negative second lens group, and a positive third lens group in order from an object side and performs focusing through allowing the second lens group to travel in an optical axis direction. The second lens group is located closer to an image plane side than the first lens group having positive refractive power, and a light beam converging from the first lens group enters the second lens group. Accordingly, the second lens group has a small lens diameter and a light weight. Using the lightweight second lens group for focusing makes it possible to perform focusing at high speed, which is suitable for shooting of a moving image.

However, in the imaging lens disclosed in PTL 1, the second lens group includes a cemented lens in which a negative lens and a positive lens are cemented together in order from the object side. With this configuration, aberrations that occur in the second lens group, in particular, spherical aberration and coma aberration, are not sufficiently corrected; therefore, this configuration is not suitable for an imaging lens of a digital camera system including an increased number of pixels.

Moreover, in the imaging lens disclosed in PTL 2, refractive power of the negative lens configuring the second lens group is low, and aberrations that occur in the second lens group, in particular, spherical aberration, are not sufficiently corrected; therefore, this configuration is not suitable for the imaging lens of the digital camera system including the increased number of pixels.

It is desirable to provide an imaging lens also suitable for shooting of a moving image while maintaining high imaging performance, and an imaging apparatus including such an imaging lens.

### Solution to Problem

An imaging lens according to an embodiment of the present disclosure includes: a first lens group having positive refractive power; a second lens group having negative refractive power; and a third lens group having positive refractive power, the first lens group, the second lens group, and the third lens group being provided in order from an object side to an image plane side, in which only the second lens group travels in an optical axis direction upon focusing, and the second lens group includes a negative lens and a positive lens in order from the object side to the image plane side with an air spacing in between, and satisfies the following conditional expression,

1.75<nn<2.20 (1)

where nn is a refractive index, at d-line, of the negative lens in the second lens group.

An imaging apparatus according to an embodiment of the present disclosure includes an imaging lens and an imaging device that outputs an imaging signal corresponding to an optical image formed by the imaging lens, and the imaging lens is configured by the imaging lens according to the foregoing present disclosure.

The imaging lens or the imaging apparatus according to the embodiment of the present disclosure includes the first lens group having positive refractive power, the second lens group having negative refractive power, and the third lens group having positive refractive power in order from the object side to the image plane side, and only the second lens group travels in the optical axis direction upon focusing. The second lens group includes the negative lens and the positive lens in order from the object side to the image plane side with the air spacing in between, and the refractive index, at d-line, of the negative lens in the second lens group satisfies a predetermined condition.

According to the imaging lens or the imaging apparatus of the embodiment of the present disclosure, in a lens system having a three-group configuration as a whole, configurations of respective lens groups are optimized, which makes it possible to achieve performance that is also suitable for shooting of a moving image while maintaining high imaging performance.

It is to be noted that effects described herein are not necessarily limited, and any of effects described in the present disclosure may be included.

### BRIEF DESCRIPTION OF THE DRAWINGS

FIG. 1 is a lens cross-sectional view of a first configuration example of an imaging lens according to an embodiment of the present disclosure.

FIG. 2 is a lens cross-sectional view of a second configuration example of the imaging lens.

FIG. 3 is a lens cross-sectional view of a third configuration example of the imaging lens.

FIG. 4 is a lens cross-sectional view of a fourth configuration example of the imaging lens.

FIG. 5 is a lens cross-sectional view of a fifth configuration example of the imaging lens.

FIG. 6 is a lens cross-sectional view of a sixth configuration example of the imaging lens.

FIG. 7 is an aberration diagram illustrating longitudinal aberrations in an infinity focusing state (an upper section) and longitudinal aberrations in a close-distance focusing state (a lower section) in a numerical example 1 in which specific numerical values are applied to the imaging lens illustrated in FIG. 1.

FIG. 8 is an aberration diagram illustrating longitudinal aberrations in an infinity focusing state (an upper section) and longitudinal aberrations in a close-distance focusing state (a lower section) in a numerical example 2 in which specific numerical values are applied to the imaging lens illustrated in FIG. 2.

FIG. 9 is an aberration diagram illustrating longitudinal aberrations in an infinity focusing state (an upper section) and longitudinal aberrations in a close-distance focusing state (a lower section) in a numerical example 3 in which specific numerical values are applied to the imaging lens illustrated in FIG. 3.

FIG. 10 is an aberration diagram illustrating longitudinal aberrations in an infinity focusing state (an upper section) and longitudinal aberrations in a close-distance focusing state (a lower section) in a numerical example 4 in which specific numerical values are applied to the imaging lens illustrated in FIG. 4.

FIG. 11 is an aberration diagram illustrating longitudinal aberrations in an infinity focusing state (an upper section) and longitudinal aberrations in a close-distance focusing state (a lower section) in a numerical example 5 in which specific numerical values are applied to the imaging lens illustrated in FIG. 5.

FIG. 12 is an aberration diagram illustrating longitudinal aberrations in an infinity focusing state (an upper section) and longitudinal aberrations in a close-distance focusing state (a lower section) in a numerical example 6 in which specific numerical values are applied to the imaging lens illustrated in FIG. 6.

FIG. 13 is a block diagram illustrating a configuration example of an imaging apparatus.

### MODES FOR CARRYING OUT THE INVENTION

In the following, some embodiments of the present disclosure are described in detail with reference to the drawings. It is to be noted that description is given in the foil owing order.
1. Basic Configuration of Lens
2. Workings and Effects
3. Application Examples to Imaging Apparatus
4. Numerical Examples of Lens
5. Other Embodiments

### 1. BASIC CONFIGURATION OF LENS

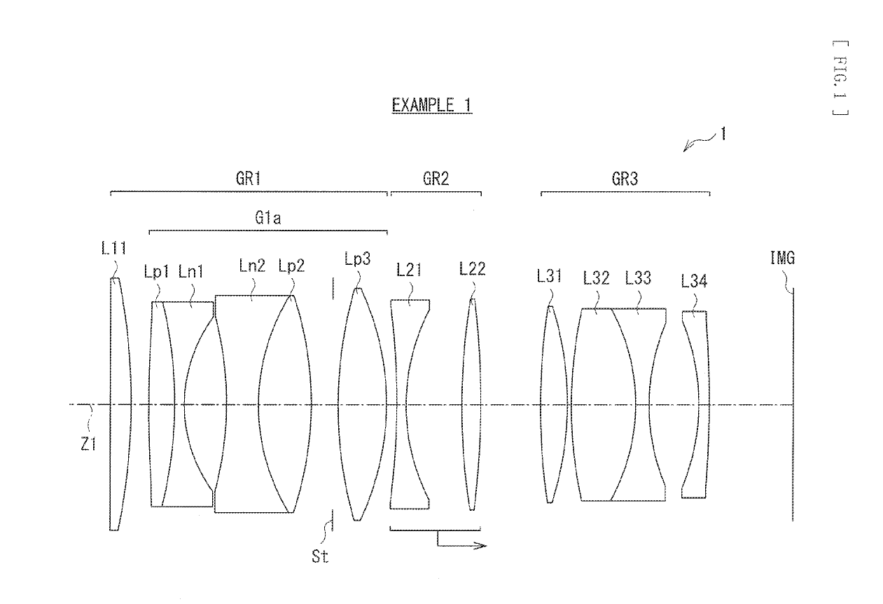

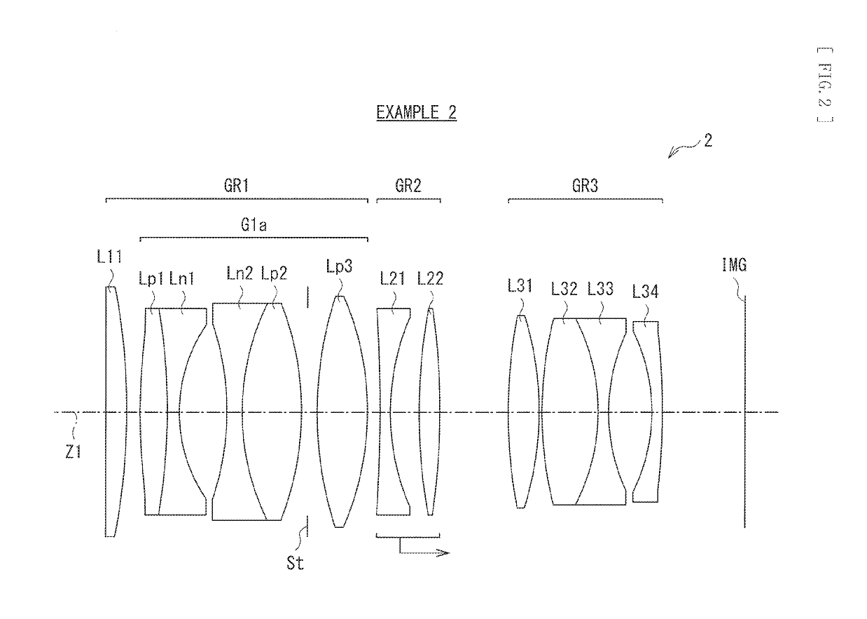

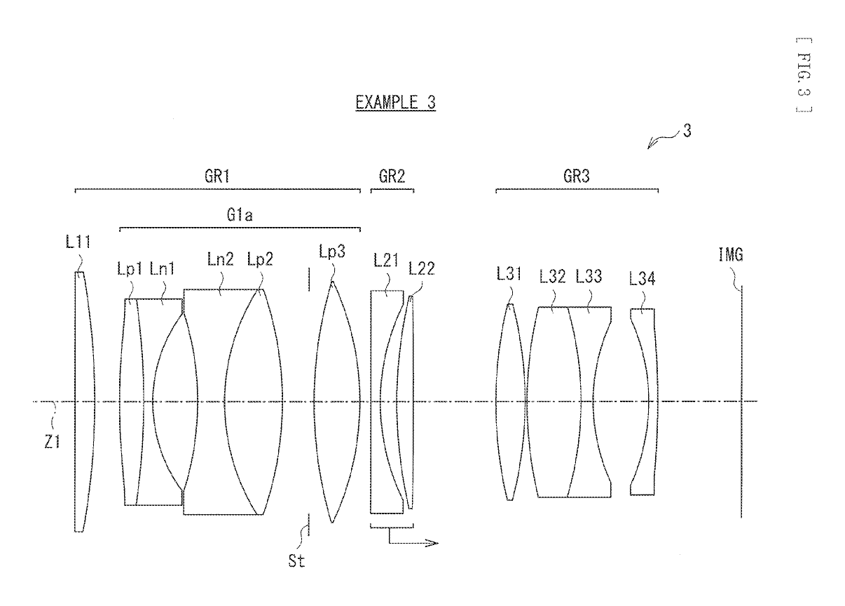

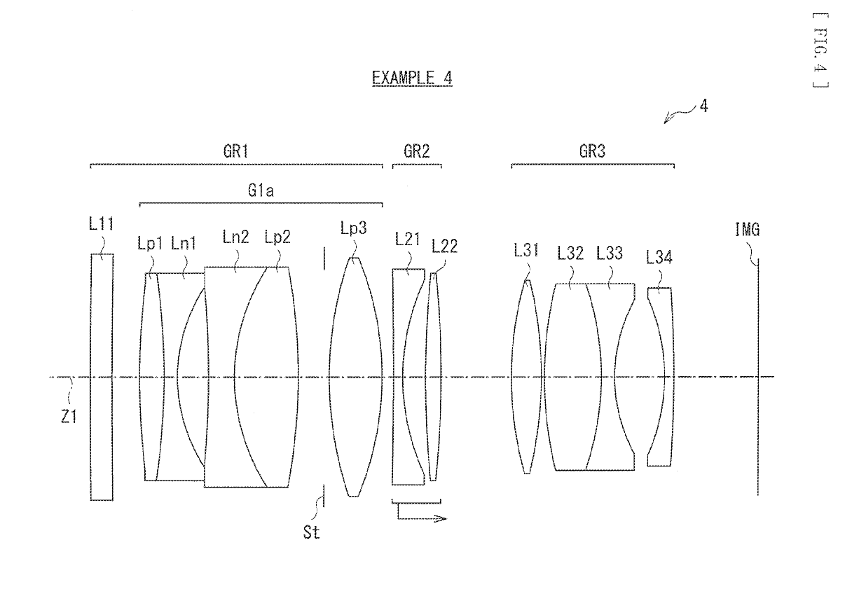

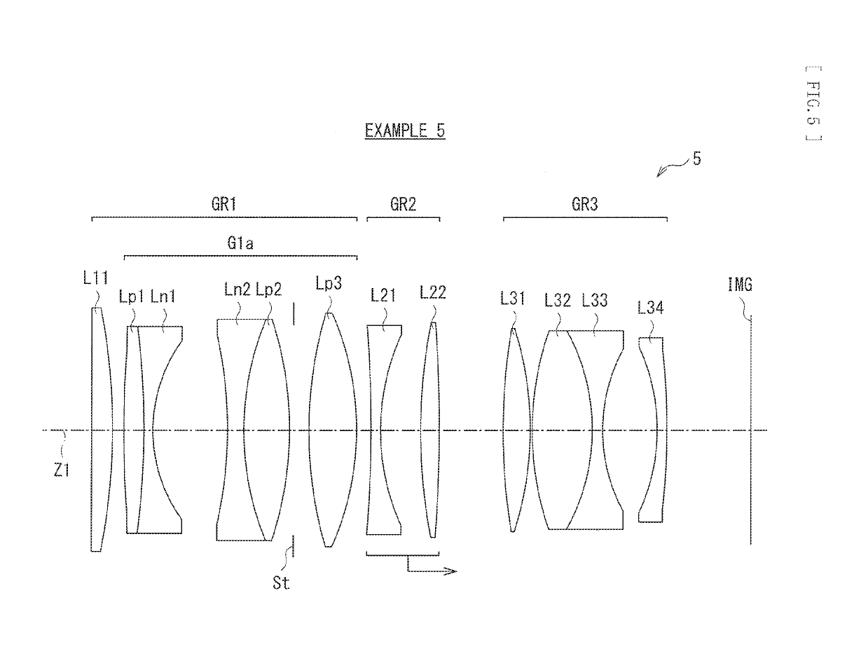

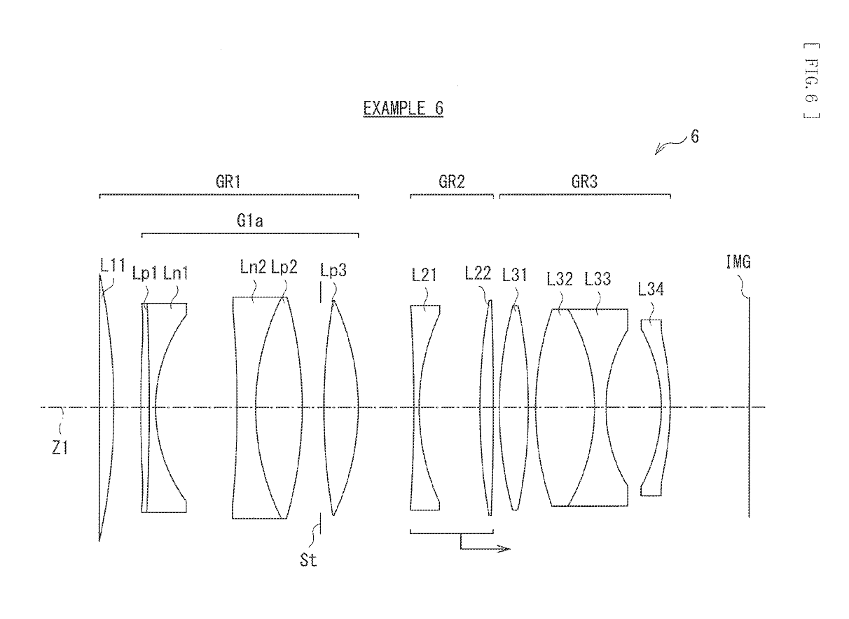

FIG. 1 illustrates a first configuration example of an imaging lens according to an embodiment of the present disclosure. FIG. 2 illustrates a second configuration example of the imaging lens. FIG. 3 illustrates a third configuration example of the imaging lens. FIG. 4 illustrates a fourth configuration example of the imaging lens. FIG. 5 illustrates a fifth configuration example of the imaging lens. FIG. 6 illustrates a sixth configuration example of the imaging lens. Numerical examples in which specific numerical values are applied to these configuration examples are described later. In FIG. 1, etc, Z1 represents an optical axis. An optical member such as a seal glass for imaging device protection and various optical filters may be provided between the imaging lens and an image plane IMG.

In the following, description is given of a configuration of the imaging lens according to the present embodiment corresponding to the configuration examples illustrated in FIG. 1 etc. as appropriate; however, the technology by the present disclosure is not limited to the illustrated configuration examples.

The imaging lens according to the present embodiment includes a first lens group GR1 having positive refractive power, a second lens group GR2 having negative refractive power, and a third lens group GR3 having positive refractive power in order along the optical axis Z1 from an object side to an image plane side.

The second lens group GR2 includes a negative lens L21 and a positive lens L22 in order from the object side to the image plane side with an air spacing in between.

Herein, FIGS. 1 to 6 each illustrate a lens cross-section in an infinity focusing state. A solid-line arrow indicates that the second lens group GR2 travels as a focus lens group on an optical axis toward an arrow direction upon focusing from an object at infinity to an object at a close distance. The first lens group GR1 and the third lens group GR3 are fixed upon focusing.

In addition, the imaging lens according to the present embodiment desirably satisfies a predetermined conditional expression to be described later, or the like.

### 2. WORKINGS AND EFFECTS

Next, description is given of workings and effects of the imaging lens according to the present embodiment. A desirable configuration in the imaging lens according to the present embodiment is described along therewith.

It is to be noted that effects described in the present description are illustrative and non-limiting, and any other effect may be included.

According to the imaging lens according to the present embodiment, in a three-group configuration as a whole, configurations of respective lens groups are optimized, which makes it possible to achieve performance that is also suitable for shooting of a moving image while maintaining high imaging performance.

Adopting the three-group configuration including a positive group, a negative group, and a positive group in order from the object side to the image plane side causes the second lens group GR2 having negative refractive power to be located closer to the image plane side than the first lens group GR1 having positive refractive power. Accordingly, a light beam converging from the first lens group GR1 enters the second lens group GR2. Hence, the second lens group GR2 has a small lens diameter, and a light weight. The weight of the second lens group GR2 is light; therefore, using the second lens group GR2 as a focus lens group allows the focus lens group to travel at high speed by an actuator.

The imaging lens according to the present embodiment desirably satisfies the following conditional expression (1).

1.75<nn<2.20 (1)

where nn is a refractive index, at d-line, of the negative lens L21 in the second lens group GR2.

The second lens group GR2 includes the negative lens L21 and the positive lens L21 in order from the object side to the image plane side with an air spacing in between, and satisfies the conditional expression (1), which makes it possible to favorably correct aberrations that occur in the second lens group GR2, in particular, specifically spherical aberration and coma aberration. Falling below the conditional expression (1) causes a radius of curvature of the negative lens L21 to be decreased, thereby deteriorating aberrations that occur in the negative lens L21, in particular, spherical aberration and coma aberration. Exceeding the conditional expression (1) causes specific gravity of a glass material to be too large, thereby increasing a lens weight and making it difficult to allow the second lens group GR2 as the focus lens group to travel at high speed.

It is to be noted that in order to more favorably achieve an effect of the foregoing conditional expression (1), a numerical range of the conditional expression (1) is desirably set to a range as represented by the following conditional expression (1)′.

1.78<nn<2.05 (1)′

Moreover, the imaging lens according to the present embodiment desirably satisfies the following conditional expression (2).

1.70<np<2.20 (2)

where np is a refractive index, at d-line, of the positive lens L22 in the second lens group GR2.

Falling below the conditional expression (2) causes a radius of curvature of the positive lens L22 in the second lens group GR2 to be decreased, thereby deteriorating aberrations that occur in the positive lens L22, in particular, spherical aberration and coma aberration. Exceeding the conditional expression (2) causes specific gravity of the glass material to be too large, thereby increasing the lens weight, and making it difficult to allow the second lens group GR2 as the focus lens group to travel at high speed.

It is to be noted that in order to more favorably achieve an effect of the foregoing conditional expression (2), a numerical range of the conditional expression (2) is desirably set to a range as represented by the following conditional expression (2)′.

1.80<np<2.15 (2)′

Moreover, the imaging lens according to the present embodiment desirably satisfies the following conditional expression (3).

0<D2a/f<0.40 (3)

where D2a is an air spacing between the negative lens L21 and the positive lens L22 in the second lens group GR2, and

f is a focal length of an entire optical system upon infinity focusing.

The conditional expression (3) is an expression defining an air spacing in the second lens group GR2 with respect to the focal length of the entire optical system upon infinity focusing. Falling below the conditional expression (3) causes the air spacing between the negative lens L21 and the positive lens L22 to be too short, thereby resulting in a too small difference between a height of a light beam outputted from the negative lens L21 and a height of a light beam entering the positive lens L22. As a result, an effect of correcting aberrations in the positive lens L22, in particular, coma aberration and field curvature, is deteriorated. Exceeding the conditional expression (3) causes the air spacing between the negative lens L21 and the positive lens L22 to be too long, thereby increasing a diameter of a light beam diverging from the negative lens L21 and entering the positive lens L22. Hence, the lens weight is increased, which is not suitable for high-speed focusing.

It is to be noted that in order to more favorably achieve an effect of the foregoing conditional expression (3), a numerical range of the conditional expression (3) is desirably set to a range as represented by the following conditional expression (3)′.

0.05<D2a/f<0.30 (3)′

Moreover, in the imaging lens according to the present embodiment, the first lens group GR1 has a surface having a concave surface facing the image plane side and a surface having a concave surface facing the object side, and a longest air spacing in the first lens group GR1 is desirably an air spacing between the surface having the concave surface facing the image plane side and the surface having the concave surface facing the object side. In this case, the following conditional expression (4) is desirably satisfied.

0.05<D1a/D1<0.50 (4)

where D1a is a longest air spacing in the first lens group GR1, and

D1 is a distance from a surface on a most object side in the first lens group GR1 to a surface on a most image plane side in the first lens group GR1.

The conditional expression (4) is an expression defining the longest air spacing in the first lens group with respect to the distance from the surface on the most object side in the first lens group GR1 to the surface on the most image plane side in the first lens group GR1. Falling below the conditional expression (4) causes the air spacing between the surface having the concave surface facing the image plane side and the surface having the concave surface facing the object side to be too narrow, thereby deteriorating symmetry of facing surfaces, and causing insufficient correction of respective aberrations, in particular, coma aberration and distortion. Exceeding the conditional expression (4) causes the air spacing between the surface having the concave surface facing the image plane side and the surface having the concave surface facing the object side to be too long, thereby increasing a height of a light beam entering the surface having the concave surface facing the object side from the optical axis, and deteriorating aberrations that occur in this surface, in particular, coma aberration and field curvature.

It is to be noted that in order to more favorably achieve an effect of the foregoing conditional expression (4), a numerical range of the conditional expression (4) is desirably set to a range as represented by the following conditional expression (4)′.

0.1<D1a/D1<0.35 (4)′

Further, the imaging lens according to the present embodiment desirably satisfies the following conditional expression (5).

−1.2<(Rp1+Rp2)/(Rp1−Rp2)<0.2 (5)

Rp1 is a radius of curvature of a surface on the object side of the positive lens L22 in the second lens group GR2, and

Rp2 is a radius of curvature of a surface on the image plane side of the positive lens L22 in the second lens group GR2.

The conditional expression (5) is an expression defining a shape factor of the positive lens L22 in the second lens group GR2. Falling below the conditional expression (5) causes the surface on the object side to become a steeply convex surface, and causes an incident angle of a light beam diverging from the negative lens L21 in the second lens group GR2 to be increased, thereby deteriorating spherical aberration. Exceeding the conditional expression (5) causes the surface on the image plane side of the positive lens L22 to become a steeply convex surface, and causes an angle of deviation of a light beam on the surface on the image plane side of the positive lens to be too large, thereby deteriorating spherical aberration.

It is to be noted that in order to more favorably achieve an effect of the foregoing conditional expression (5), a numerical range of the conditional expression (5) is desirably set to a range as represented by the following conditional expression (5)′.

−1.0<(Rp1+Rp2)/(Rp1−Rp2)<0.0 (5)′

Furthermore, the imaging lens according to the present embodiment desirably satisfies the following conditional expression (6).

−3.0<f2/f<−1.50 (6)

where f is a focal length of the entire optical system upon infinity focusing, and

f2 is a focal length of the second lens group GR2.

The conditional expression (6) is an expression defining the focal length of the second lens group GR2 with respect to the focal length of the entire optical system upon infinity focusing. Falling below the conditional expression (6) causes power of the second lens group GR2 to be too strong, thereby resulting in small radii of curvature of the lenses configuring the second lens group GR2, and deteriorating aberrations that occur in the second lens group GR2, in particular, spherical aberration and coma aberration. Exceeding the conditional expression (6) causes the power of the second lens group GR2 to be too weak, thereby resulting in small focusing sensitivity of the second lens group GR2 and increasing a traveling distance upon focusing. The increased traveling distance upon focusing increases time for focusing, which is not suitable for shooting of a moving image.

It is to be noted that in order to more favorably achieve an effect of the foregoing conditional expression (6), a numerical range of the conditional expression (6) is desirably set to a range as represented by the following conditional expression (6)′.

−2.6<f2/f<−1.8 (6)′

Moreover, in the imaging lens according to the present embodiment, the first lens group GR1 desirably includes a positive lens L11 located on the most object side, and at least two negative lenses and one positive lens that are located closer to the image plane side than the positive lens L11 located on the most object side. Locating the positive lens L11 on the most object side of the first lens group GR1 makes it possible to reduce an incident height of a light beam onto a lens located closer to the image plane side than the positive lens L11 and to suppress occurrence of spherical aberration in the lens located on the image plane side. Further, having at least two negative lenses and one positive lens on the image plane side of the positive lens L11 makes it possible to favorably correct aberrations that occur in the first lens group GR1, in particular, on-axis chromatic aberration.

Furthermore, in the imaging lens according to the present embodiment, the first lens group GR1 desirably includes a partial lens group G1a having positive refractive power, and the partial lens group G1a desirably includes a first positive lens Lp1, a first negative lens Ln1, a second negative lens Ln2, a second positive lens Lp2, and a third positive lens Lp3 in order from the object side to the image plane side. Adopting such a configuration makes it possible for the first lens group GR1 to have a high symmetric configuration in which a positive lens is interposed between two negative lenses, and makes it possible to favorably correct aberrations that occur in the first lens group GR1, in particular, distortion.

Moreover, in the imaging lens according to the present embodiment, the partial lens group G1a desirably includes a first cemented lens in which the first positive lens Lp1 and the first negative lens Ln1 are cemented together and a second cemented lens in which the second negative lens Ln2 and the second positive lens Lp2 are cemented together. Adopting such a configuration makes it possible to reduce decentering sensitivity of the first positive lens Lp1 and the first negative lens Ln1 and decentering sensitivity of the second negative lens Ln2 and the second positive lens Lp2, and makes it possible to stably manufacture a lens barrel having high resolution.

### 3. APPLICATION EXAMPLES TO IMAGING APPARATUS

Next, description is given of application examples of the imaging lens according to the present embodiment to an imaging apparatus.

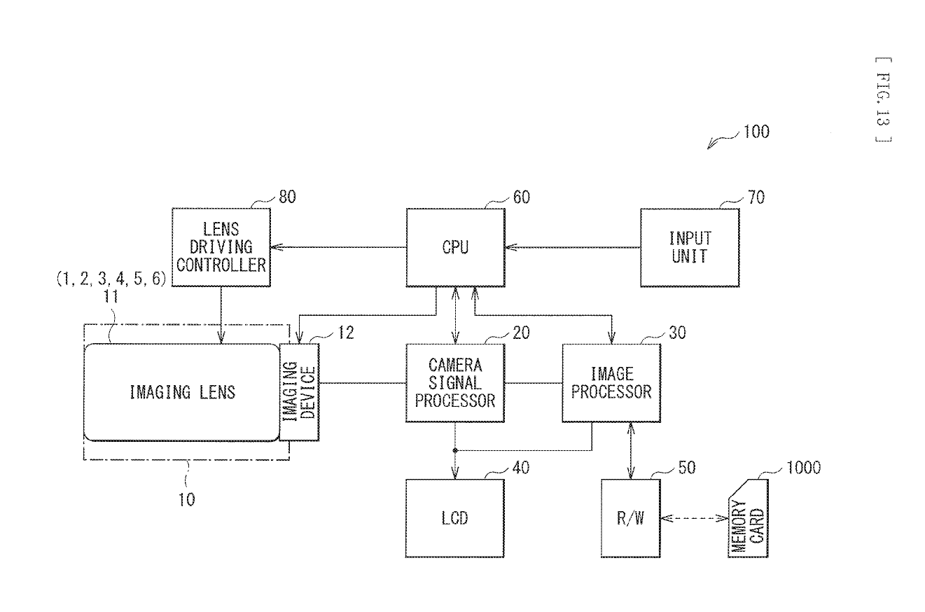

FIG. 13 illustrates a configuration example of an imaging apparatus 100 to which the imaging lens according to the present embodiment is applied. The imaging apparatus 100 is, for example, a digital still camera, and includes a camera block 10, a camera signal processor 20, an image processor 30, an LCD (Liquid Crystal Display) 40, a R/W (reader/writer) 50, a CPU (Central Processing Unit) 60, an input unit 70, and a lens driving controller 80.

The camera block 10 has an imaging function, and includes an optical system including the imaging lens 11, and an imaging device 12 such as a CCD (Charge Coupled Devices) and a CMOS (Complementary Metal Oxide Semiconductor). The imaging device 12 converts an optical image formed by the imaging lens 11 into an electrical signal to output an imaging signal (an image signal) corresponding the optical image. As the imaging lens 11, imaging lenses 1 to 6 of respective configuration examples illustrated in FIGS. 1 to 6 are applicable.

The camera signal processor 20 performs, on the image signal outputted from the imaging device 12, various kinds of signal processing such as analog-to-digital conversion, noise removal, image quality correction, conversion into a luminance-color difference signal.

The image processor 30 performs recording and reproducing processing on the image signal, and performs compression encoding and expansion decoding processing on the image signal on the basis of a predetermined image data format, conversion processing of data specifications such as resolution, and the like.

The LCD 40 has a function of displaying various kinds of data such as an operation state of the input unit 70 by a user and a shot image. The R/W 50 writes image data encoded by the image processor 30 to a memory card 1000 and reads image data recorded in the memory card 1000. The memory card 1000 is, for example, a semiconductor memory attachable to and detachable from a slot coupled to the R/W 50.

The CPU 60 functions as a control processor that controls respective circuit blocks provided in the imaging apparatus 100, and controls the respective circuit blocks on the basis of an instruction input signal from the input unit 70, or the like. The input unit 70 includes various kinds of switches, etc. on which a desired operation is performed by the user. The input unit 70 includes, for example, a shutter release button used to perform a shutter operation, a selection switch used to select an operation mode, and the like, and outputs an instruction input signal corresponding to an operation by the user to the CPU 60. The lens driving controller 80 controls driving of lenses provided in the camera block 10, and controls an unillustrated motor, etc. that drives respective lenses of the imaging lens 11 on the basis of a control signal from the CPU 60.

An operation in the imaging apparatus 100 is described below.

In a standby state for shooting, under control by the CPU 60, an image signal shot by the camera block 10 is outputted to the LCD 40 through the camera signal processor 20 to display the image signal as a camera-through image. Moreover, in a case where, for example, an instruction input signal for focusing from the input unit 70 is inputted, the CPU 60 outputs a control signal to the lens driving controller 80, and a predetermined lens of the imaging lens 11 travels on the basis of control by the lens driving controller 80.

In a case where an unillustrated shutter of the camera block 10 is operated by the instruction input signal from the input unit 70, the shot image signal is outputted from the camera signal processor 20 to the image processor 30, and is subjected to compression encoding processing to be converted into digital data having a predetermined data format. The converted data is outputted to the RAY 50 to be written to the memory card 1000.

It is to be noted that focusing is performed through causing a predetermined lens of the imaging lens 11 by the lens driving controller 80 to travel on the basis of a control signal from the CPU 60, for example, in a case where the shutter release button is half-pressed, a case where the shutter release button is full-pressed for recording (shooting), or the like.

In a case where image data recorded in the memory card 1000 is reproduced, in accordance with an operation on the input unit 70, predetermined image data is read from the memory card 1000 by the R/W 50, and is subjected to expansion decoding by the image processor 30. Thereafter, a reproduced image signal is outputted to the LCD 40 to display a reproduced image.

It is to be noted that the foregoing embodiment involves an example in which the imaging apparatus is applied to a digital still camera etc.; however, an application range of the imaging apparatus is not limited to the digital still camera, and the imaging apparatus is applicable to various other imaging apparatuses. For example, the imaging apparatus is applicable to a digital single-lens reflex camera, a digital nonreflex camera, a digital video camera, a surveillance camera, etc. Moreover, the imaging apparatus is widely applicable as a camera unit, etc. of a digital input-output device such as a mobile phone with a built-in camera and an information terminal with a built-in camera. Moreover, the imaging apparatus is also applicable to an interchangeable-lens camera.

### Examples

### 4. NUMERICAL EXAMPLES OF LENS

Next, description is given of specific numerical examples of the imaging lens according to the present embodiment. Herein, description is given of numerical examples in which specific numerical values are applied to the imaging lenses 1 to 6 of respective configuration examples illustrated in FIGS. 1 to 6.

It is to be noted that meanings etc. of symbols in the following respective tables and the following description are as follows. “Surface No.” represents the number of an i-th surface counted from the object side to the image plane side. “Ri” represents a value (mm) of a paraxial radius of curvature of the i-th surface. “Di” represents a value (mm) of a spacing on the optical axis between the i-th surface and an i+1-th surface. “Ndi” represents a value of a refractive index, at d-line (having a wavelength of 587.6 nm), of a material of an optical component that has the i-th surface. “vdi” represents a value of an Abbe number, at d-line, of the material of the optical component that has the i-th surface. A section in which the value of “Ri” is “∞” indicates that a surface relevant thereto is a planar surface or an aperture stop (an aperture stop St). A surface provided with “ASP” indicates an aspherical surface. A surface provided with “STO” indicates the aperture stop St. “f” represents a focal length of an entire optical system upon infinity focusing, “Fno” represents an F-number, and “ω” represents a half angle of view. “β” represents a magnification upon focusing.

In each of the numerical examples, an aspherical surface shape is defined by the following expression of an aspherical surface. It is to be noted that in respective tables indicating aspherical surface coefficients to be described later, a power of 10 is represented by E. To give an example, “1.2×10⁻⁰²” is represented by “1.2E-02”.

### (Expression of Aspherical Surface)

x=c²y²/[1+{1−(1+K)c²y²}^{1/2}]+ΣAi·yⁱ

Herein,

x is a distance in an optical axis direction from a lens surface apex,

y is a height in a direction perpendicular to an optical axis,

c is a paraxial curvature at a lens apex (the inverse of a paraxial radius of curvature),

K is a conic constant, and

Ai is an i-th-order aspherical coefficient.

### (Configuration Common to Numerical Examples)

Each of the imaging lenses 1 to 6 to which the following respective numerical examples are applied also has a configuration that satisfies the above-described basic configuration of the lens and a desirable configuration. In other words, each of the imaging lenses 1 to 6 includes the first lens group GR1 having positive refractive power, the second lens group GR2 having negative refractive power, and the third lens group GR3 having positive refractive power in order from the object side to the image plane side.

The second lens group GR2 includes the negative lens L21 and the positive lens L22 in order from the object side to the image plane side with an air spacing in between. The second lens group GR2 travels as the focus lens group upon focusing.

The first lens group GR1 includes the positive lens L11 located on the most object side and the partial lens group G1a located closer to the image plane side than the positive lens L11 and having positive refractive power. The partial lens group G1a includes the first positive lens Lp1, the first negative lens Ln1, the second negative lens Ln2, the second positive lens Lp2, and the third positive lens Lp3 in order from the object side to the image plane side. The first cemented lens in which the first positive lens Lp1 and the first negative lens Ln1 are cemented together is configured, and the second cemented lens in which the second negative lens Ln2 and the second positive lens Lp2 are cemented together is configured.

The aperture stop St is provided between the second positive lens Lp2 and the third positive lens Lp3 in the partial lens group G1a.

### Numerical Example 1

[Table 1] illustrates basic lens data of the numerical example 1 in which specific numerical values are applied to the imaging lens 1 illustrated in FIG. 1. Moreover, [Table 2] illustrates values of coefficients in the aspherical surface. Further, [Table 3] illustrates values of the focal length f, the F-number (Fno), and the half angle of view ω of the entire optical system upon infinity focusing.

Furthermore, [Table 4] illustrates values of variable surface separations. In the numerical example 1, values of surface separations D11 and D15 vary upon focusing. Moreover, for reference, [Table 4] illustrates a value of a back focus as D22.

Further, [Table 5] illustrates a start surface of lens surfaces in each group and a value of a focal length of each group.

In the imaging lens 1 according to the numerical example 1, the first lens group GR1 includes a biconvex lens (the positive lens L11), a cemented lens in which a biconvex lens (the first positive lens Lp1) using an aspherical surface on the object side and a biconcave lens (the first negative lens Ln1) are bonded together, a cemented lens in which a biconcave lens (the second negative lens Ln2) and a biconvex lens (the second positive lens Lp2) are cemented together, and a biconvex lens (the third positive lens Lp3) in order from the object side to the image plane side.

The second lens group GR2 includes a biconcave lens (the negative lens L21) and a biconvex lens (the positive lens L22) in order from the object side to the image plane side.

The third lens group GR3 includes a biconvex lens L31, a cemented lens in which a biconvex lens L32 and a biconcave lens L33 are cemented together, and a negative meniscus lens L34 using an aspherical surface on the image plane side and having a concave surface facing the object side in order from the object side to the image plane side.

TABLE 1
Example 1

| Surface No | Ri | Di | ndi | νdi |
|---|---|---|---|---|
| 1 | 9999.000 | 3.822 | 1.72341 | 37.9 |
| 2 | −122.590 | 3.253 | | |
| 3 (ASP) | 138.127 | 4.774 | 1.85134 | 40.1 |
| 4 | −85.878 | 1.800 | 1.51679 | 64.1 |
| 5 | 28.126 | 7.823 | | |
| 6 | −69.703 | 6.000 | 1.71735 | 29.5 |
| 7 | 38.956 | 9.863 | 1.72916 | 54.6 |
| 8 | −63.032 | 3.929 | | |
| 9 (STO) | ∞ | 1.000 | | |
| 10 | 76.306 | 8.926 | 1.59282 | 68.6 |
| 11 | −50.948 | (D11) | | |
| 12 | −151.852 | 1.800 | 1.80438 | 42.1 |
| 13 | 40.087 | 10.280 | | |
| 14 | 124.632 | 3.529 | 1.84666 | 23.7 |
| 15 | −149.575 | (D15) | | |
| 16 | 128.437 | 4.927 | 1.80419 | 46.5 |
| 17 | −62.243 | 0.731 | | |
| 18 | 82.090 | 12.000 | 1.80419 | 46.5 |
| 19 | −37.584 | 2.500 | 1.80518 | 25.4 |
| 20 | 42.697 | 9.206 | | |
| 21 | −40.645 | 1.800 | 1.58312 | 59.3 |
| 22 (ASP) | −119.367 | (D22) | | |

TABLE 2
Example 1

| Surface No | K | A4 | A6 |
|---|---|---|---|
| 3 | 0.0000E+00 | −4.6699E−06 | −1.5185E−09 |
| 22 | 0.0000E+00 | 6.4640E−06 | −8.1406E−10 |
| Surface No | A8 | A10 | A12 |
| 3 | 9.3010E−13 | −3.6800E−16 | 0.0000E+00 |
| 22 | 2.0615E−11 | −1.7873E−14 | 0.0000E+00 |

TABLE 3
Example 1

| | |
|---|---|
| f | 51.53 |
| Fno | 1.45 |
| ω | 22.71 |

TABLE 4
Example 1

| | | | |
|---|---|---|---|
| β | 0.00 | 0.03 | 0.16 |
| D11 | 2.000 | 3.828 | 11.133 |
| D15 | 11.133 | 9.305 | 2.000 |
| D22 | 15.506 | 15.506 | 15.506 |

TABLE 5
Example 1

| | Start Surface | Focal Length |
|---|---|---|
| GR1 | 1 | 48.111 |
| GR2 | 12 | −105.58 |
| GR3 | 16 | 115.88 |

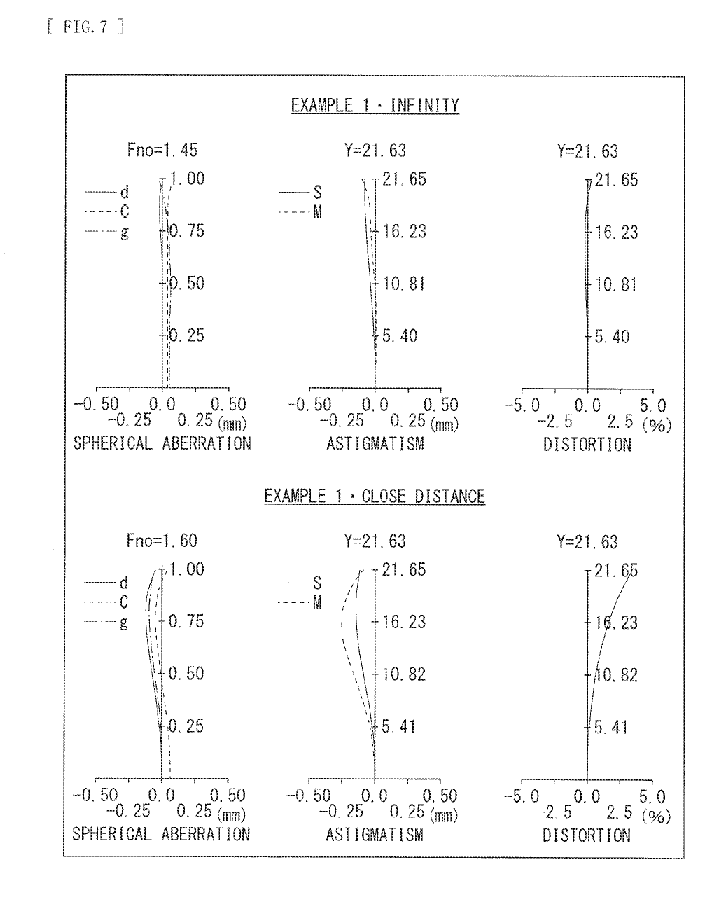

An upper section in FIG. 7 illustrates longitudinal aberrations in an infinity focusing state in the numerical example 1. A lower section in FIG. 7 illustrates longitudinal aberrations in a close-distance focusing state in the numerical example 1. FIG. 7 illustrates spherical aberration, astigmatism (field curvature), and distortion as longitudinal aberrations. In a diagram of astigmatism, a solid line (S) indicates a value on a sagittal image plane, and a broken line (M) indicates a value on a meridional image plane. Respective aberration diagrams illustrate values at d-line. A diagram of spherical aberration also illustrates values at C-line (having a wavelength of 656.3 nm) and g-line (having a wavelength of 435.8 nm). This applies to aberration diagrams in the following other numerical examples.

As can be seen from respective aberration diagrams, it is clear that in the imaging lens 1 according to the numerical example 1, in the infinity focusing state and the close-distance focusing state, respective aberrations are favorably corrected, variation in performance by focusing is small, and the imaging lens 1 has superior imaging performance.

### Numerical Example 2

[Table 6] illustrates basic lens data of the numerical example 2 in which specific numerical values are applied to the imaging lens 2 illustrated in FIG. 2. Moreover, [Table 7] illustrates values of coefficients in the aspherical surface. Further, [Table 8] illustrates values of the focal length f, the F-number (Fno), and the half angle of view ω of the entire optical system upon infinity focusing.

Furthermore, [Table 9] illustrates values of variable surface separations. In the numerical example 2, values of surface separations D11 and D15 vary upon focusing. Moreover, for reference, [Table 9] illustrates a value of a back focus as D22.

Further, [Table 10] illustrates a start surface of lens surfaces in each group and a value of a focal length of each group.

In the imaging lens 2 according to the numerical example 2, the first lens group GR1 includes a biconvex lens (the positive lens L11), a cemented lens in which a biconvex lens (the first positive lens Lp1) using an aspherical surface on the object side and a biconcave lens (the first negative lens Ln1) are cemented together, a cemented lens in which a biconcave lens (the second negative lens Ln2) and a biconvex lens (the second positive lens Lp2) are cemented together, and a biconvex lens (the third positive lens Lp3) in order from the object side to the image plane side.

The second lens group GR2 includes a biconcave lens (the negative lens L21) and a biconvex lens (the positive lens L22) in order from the object side to the image plane side.

The third lens group GR3 includes the biconvex lens L31, a cemented lens in which the biconvex lens L32 and the biconcave lens L33 are cemented together, and the negative meniscus lens L34 using an aspherical surface on the image plane side and having a concave surface facing the object side in order from the object side to the image plane side.

TABLE 6
Example 2

| Surface No | Ri | Di | ndi | νdi |
|---|---|---|---|---|
| 1 | 9999.000 | 3.887 | 1.72341 | 37.9 |
| 2 | −128.215 | 2.552 | | |
| 3 (ASP) | 114.514 | 4.946 | 1.85134 | 40.1 |
| 4 | −116.373 | 2.178 | 1.51679 | 64.1 |
| 5 | 28.120 | 8.835 | | |
| 6 | −51.934 | 2.897 | 1.71735 | 29.5 |
| 7 | 44.703 | 10.940 | 1.72916 | 54.6 |
| 8 | −54.876 | 1.144 | | |
| 9 (STO) | ∞ | 1.764 | | |
| 10 | 68.142 | 9.350 | 1.59282 | 68.6 |
| 11 | −54.525 | (D11) | | |
| 12 | −243.918 | 1.800 | 1.99502 | 29.3 |
| 13 | 44.296 | 5.450 | | |
| 14 | 105.875 | 3.768 | 1.94594 | 17.9 |
| 15 | −150.783 | (D15) | | |
| 16 | 93.568 | 5.822 | 1.80419 | 46.5 |
| 17 | −62.024 | 0.500 | | |
| 18 | 70.486 | 10.360 | 1.80419 | 46.5 |
| 19 | −37.614 | 1.931 | 1.80518 | 25.4 |
| 20 | 34.944 | 8.141 | | |
| 21 | −34.288 | 1.800 | 1.58312 | 59.3 |
| 22 (ASP) | −96.201 | (D22) | | |

TABLE 7
Example 2

| Surface No | K | A4 | A6 |
|---|---|---|---|
| 3 | 0.0000E+00 | −4.5136E−06 | −1.7517E−09 |
| 22 | 0.0000E+00 | 7.3383E−06 | 1.6537E−09 |
| Surface No | A8 | A10 | A12 |
| 3 | 1.8300E−14 | 0.0000E+00 | 0.0000E+00 |
| 22 | 2.1185E−11 | −1.5608E−14 | 0.0000E+00 |

TABLE 8
Example 2

| | |
|---|---|
| f | 50.29 |
| Fno | 1.45 |
| ω | 23.19 |

TABLE 9
Example 2

| | | | |
|---|---|---|---|
| β | 0.00 | 0.03 | 0.15 |
| D11 | 2.442 | 4.592 | 12.782 |
| D15 | 12.684 | 10.534 | 2.344 |
| D22 | 15.506 | 15.506 | 15.506 |

TABLE 10
Example 2

| | Start Surface | Focal Length |
|---|---|---|
| GR1 | 1 | 49.989 |
| GR2 | 12 | −112.081 |
| GR3 | 16 | 122.6 |

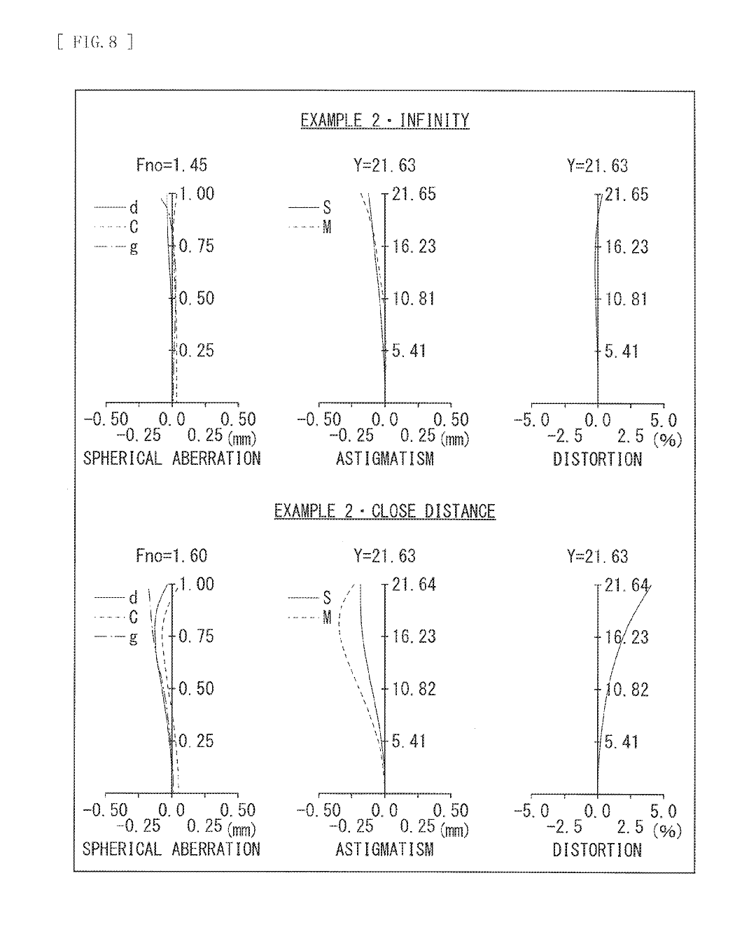

An upper section in FIG. 8 illustrates longitudinal aberrations in an infinity focusing state in the numerical example 2. A lower section in FIG. 8 illustrates longitudinal aberrations in a close-distance focusing state in the numerical example 2.

As can be seen from respective aberration diagrams, it is clear that in the imaging lens 2 according to the numerical example 2, in the infinity focusing state and the close-distance focusing state, respective aberrations are favorably corrected, variation in performance by focusing is small, and the imaging lens 2 has superior imaging performance.

### Numerical Example 3

[Table 11] illustrates basic lens data of the numerical example 3 in which specific numerical values are applied to the imaging lens 3 illustrated in FIG. 3. Moreover, [Table 12] illustrates values of coefficients in the aspherical surface. Further, [Table 13] illustrates values of the focal length f, the F-number (Fno), and the half angle of view ω of an entire optical system upon infinity focusing.

Furthermore, [Table 14] illustrates values of variable surface separations. In the numerical example 3, values of surface separations D11 and D15 vary upon focusing. Moreover, for reference, [Table 14] illustrates a value of a back focus as D22.

Further, [Table 15] illustrates a start surface of lens surfaces in each group and a value of a focal length of each group.

In the imaging lens 3 according to the numerical example 3, the first lens group GR1 includes a biconvex lens ((the positive lens L11), a cemented lens in which a biconvex lens (the first positive lens Lp1) using an aspherical surface on the object side and a biconcave lens (the first negative lens Ln1) are cemented together, a cemented lens in which a biconcave lens (the second negative lens L and a biconvex lens (the second positive lens Lp2) are cemented together, and a biconvex lens (the third positive lens Lp3) in order from the object side to the image plane side.

The second lens group GR2 includes a negative meniscus lens (the negative lens L21) having a convex surface facing the object side and a biconvex lens (the positive lens L22).

The third lens group GR3 includes the biconvex lens L31, a cemented lens in which the biconvex lens L32 and the biconcave lens L33 are cemented together, and the negative meniscus lens L34 using an aspherical surface on the image plane side and having a concave surface facing the object side in order from the object side to the image plane side.

TABLE 11
Example 3

| Surface No | Ri | Di | ndi | νdi |
|---|---|---|---|---|
| 1 | 9999.000 | 3.615 | 1.72341 | 37.9 |
| 2 | −145.001 | 4.699 | | |
| 3 (ASP) | 110.928 | 4.305 | 1.85134 | 40.1 |
| 4 | −138.654 | 1.800 | 1.51679 | 64.1 |
| 5 | 28.284 | 8.140 | | |
| 6 | −59.944 | 5.165 | 1.71735 | 29.5 |
| 7 | 39.249 | 10.590 | 1.72916 | 54.6 |
| 8 | −67.898 | 5.016 | | |
| 9 (STO) | ∞ | 1.000 | | |
| 10 | 81.463 | 8.518 | 1.59282 | 68.6 |
| 11 | −53.297 | (D11) | | |
| 12 | 2340.952 | 1.800 | 1.8348 | 42.7 |
| 13 | 42.266 | 3.000 | | |
| 14 | 86.295 | 3.055 | 1.8551 | 22.1 |
| 15 | −3731.420 | (D15) | | |
| 16 | 79.033 | 5.316 | 1.80419 | 46.5 |
| 17 | −73.445 | 0.500 | | |
| 18 | 75.335 | 9.892 | 1.80419 | 46.5 |
| 19 | −67.692 | 2.415 | 1.80518 | 25.4 |
| 20 | 38.187 | 10.050 | | |
| 21 | −39.149 | 1.800 | 1.58312 | 59.3 |
| 22 (ASP) | −124.538 | (D22) | | |

TABLE 12
Example 3

| Surface No | K | A4 | A6 |
|---|---|---|---|
| 3 | 0.0000E+00 | −4.2942E−06 | −1.7131E−09 |
| 22 | 0.0000E+00 | 6.6641E−06 | −1.0093E−09 |
| Surface No | A8 | A10 | A12 |
| 3 | −2.9030E−13 | 5.7100E−16 | 0.0000E+00 |
| 22 | 1.7866E−11 | −2.0069E−14 | 0.0000E+00 |

TABLE 13
Example 3

| | |
|---|---|
| f | 51.54 |
| Fno | 1.45 |
| ω | 22.79 |

TABLE 14
Example 3

| | | | |
|---|---|---|---|
| β | 0.00 | 0.03 | 0.16 |
| D11 | 2.000 | 4.690 | 15.373 |
| D15 | 15.373 | 12.683 | 2.000 |
| D22 | 15.536 | 15.536 | 15.536 |

TABLE 15
Example 3

| | Start Surface | Focal Length |
|---|---|---|
| GR1 | 1 | 56.237 |
| GR2 | 12 | −115.6 |
| GR3 | 16 | 109.663 |

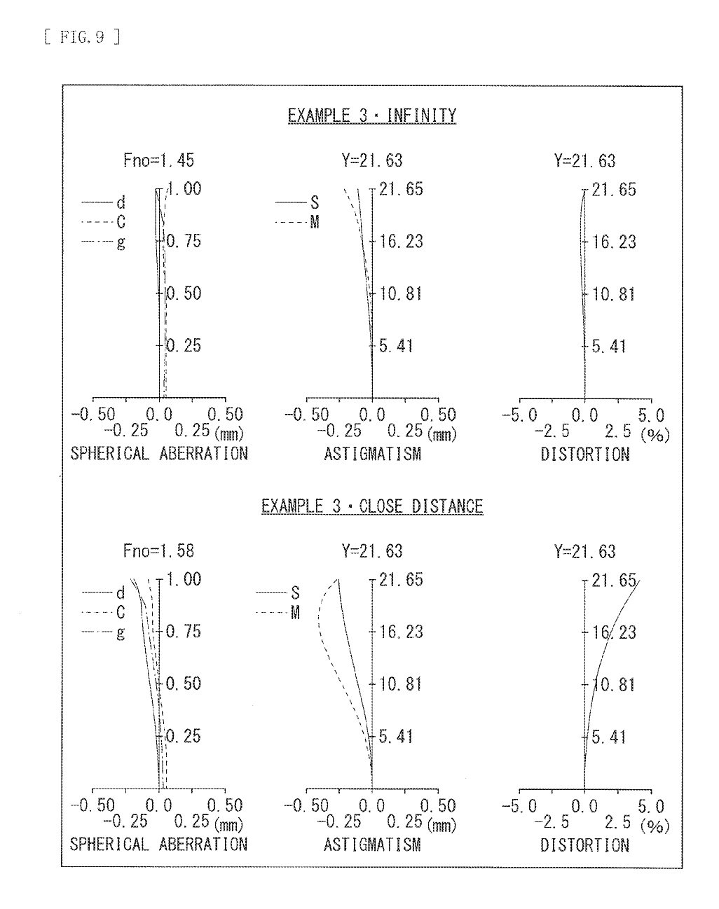

An upper section in FIG. 9 illustrates longitudinal aberrations in an infinity focusing state in the numerical example 3. A lower section in FIG. 9 illustrates longitudinal aberrations in a close-distance focusing state in the numerical example 3.

As can be seen from respective aberration diagrams, it is clear that in the imaging lens 3 according to the numerical example 3, in the infinity focusing state and the close-distance focusing state, respective aberrations are favorably corrected, variation in performance by focusing is small, and the imaging lens 3 has superior imaging performance.

### Numerical Example 4

[Table 16] illustrates basic lens data of the numerical example 4 in which specific numerical values are applied to the imaging lens 4 illustrated in FIG. 4. Moreover, [Table 17] illustrates values of coefficients in the aspherical surface. Further, [Table 18] illustrates values of a focal length f, an F-number (Fno), and a half angle of view ω of an entire optical system upon infinity focusing.

Furthermore, [Table 19] illustrates values of variable surface separations. In the numerical example 4, values of surface separations D11 and D1.5 vary upon focusing. Moreover, for reference, [Table 19] illustrates a value of a back focus as D22.

Further, [Table 20] illustrates a start surface of lens surfaces in each group and a value of a focal length of each group.

In the imaging lens 4 according to the numerical example 4, the first lens group GR1 includes a positive meniscus lens (the positive lens L11) having a convex surface facing the object side, a cemented lens in which a biconvex lens (the first positive lens Lp1) using an aspherical surface on the object side and a biconcave lens (the first negative lens Ln1) are cemented together, and a cemented lens in which a biconcave lens (the second negative lens Ln2) and a biconvex lens (the second positive lens Lp2) are cemented together, and a biconvex lens (the third positive lens Lp3) in order from the object side to the image plane side.

The second lens group GR2 includes a biconcave lens (the negative lens L21) and a biconvex lens (the positive lens L22) in order from the object side to the image plane side.

The third lens group GR3 includes the biconvex lens L31, a cemented lens in which the biconvex lens L32 and the biconcave lens L33 are cemented together, and the negative meniscus lens L34 using an aspherical surface on the image plane side and having a concave surface facing the object side in order from the object side to the image plane side.

TABLE 16
Example 4

| Surface No | Ri | Di | ndi | νdi |
|---|---|---|---|---|
| 1 | 868.123 | 4.181 | 1.72341 | 37.9 |
| 2 | 1250.898 | 4.931 | | |
| 3 (ASP) | 103.902 | 4.630 | 1.85134 | 40.1 |
| 4 | −129.916 | 2.546 | 1.51679 | 64.1 |
| 5 | 32.187 | 5.732 | | |
| 6 | −165.145 | 4.700 | 1.71735 | 29.5 |
| 7 | 36.637 | 12.000 | 1.72916 | 54,6 |
| 8 | −106.948 | 4.705 | | |
| 9 (STO) | ∞ | 1.014 | | |
| 10 | 68.368 | 9.814 | 1.59282 | 68.6 |
| 11 | −56.976 | (D11) | | |
| 12 | −1154.900 | 1.800 | 1,88299 | 40.8 |
| 13 | 42.739 | 4.125 | | |
| 14 | 174.319 | 2.894 | 1.92286 | 20.8 |
| 15 | −188.497 | (D15) | | |
| 16 | 65.631 | 5.655 | 1.80419 | 46.5 |
| 17 | −76.826 | 0.500 | | |
| 18 | 69.150 | 10.630 | 1.80419 | 46.5 |
| 19 | −53.954 | 2.500 | 1.80518 | 25.4 |
| 20 | 31.390 | 9.180 | | |
| 21 | −37.969 | 1.800 | 1.58312 | 59.3 |
| 22 (ASP) | −104.219 | (D22) | | |

TABLE 17
Example 4

| Surface No | K | A4 | A6 |
|---|---|---|---|
| 3 | 0.0000E+00 | −3.5735E−06 | −1.1949E−09 |
| 22 | 0.0000E+00 | 5.6872E−06 | 6.1815E−09 |
| Surface No | A8 | A10 | A12 |
| 3 | 3.0830E−13 | −2.3300E−16 | 0.0000E+00 |
| 22 | 2.8041E−12 | 2.0058E−14 | 0.0000E+00 |

TABLE 18
Example 4

| | |
|---|---|
| f | 51.54 |
| Fno | 1.48 |
| ω | 23.04 |

TABLE 19
Example 4

| | | | |
|---|---|---|---|
| β | 0.00 | 0.03 | 0.16 |
| D11 | 2.000 | 4.229 | 13.067 |
| D15 | 13.067 | 10.838 | 2.000 |
| D22 | 15.506 | 15.506 | 15.506 |

TABLE 20
Example 4

| | Start Surface | Focal Length |
|---|---|---|
| GR1 | 1 | 53.148 |
| GR2 | 12 | −97.853 |
| GR3 | 16 | 104.431 |

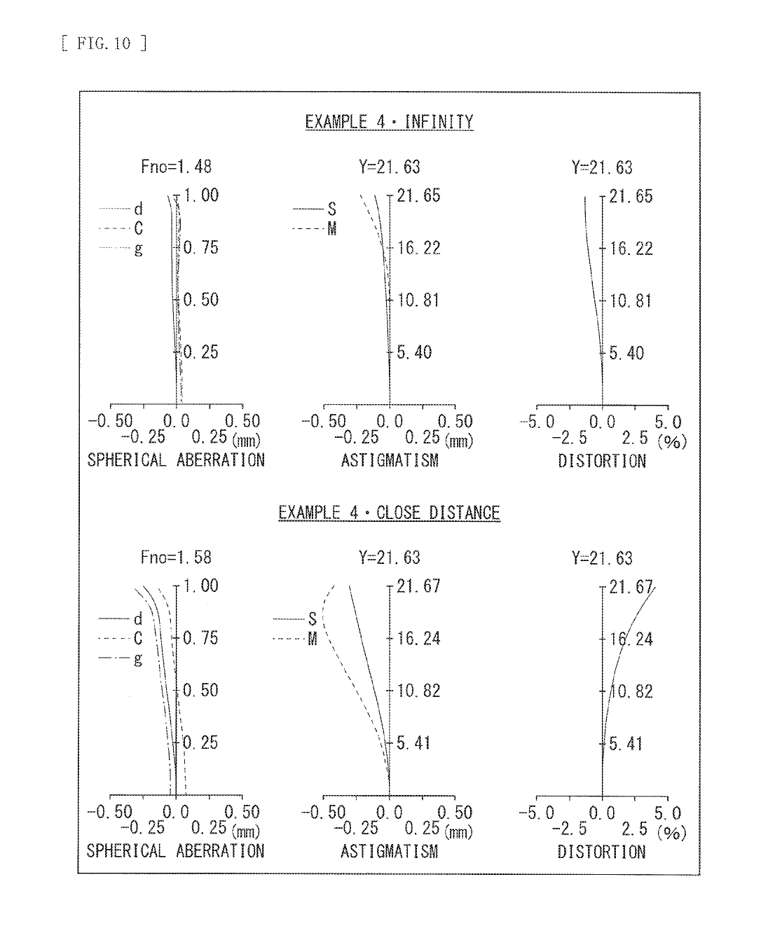

An upper section in FIG. 10 illustrates longitudinal aberrations in an infinity focusing state in the numerical example 4. A lower section in FIG. 10 illustrates longitudinal aberrations in a close-distance focusing state in the numerical example 4.

As can be seen from respective aberration diagrams, it is clear that in the imaging lens 4 according to the numerical example 4, in the infinity focusing state and the close-distance focusing state, respective aberrations are favorably corrected, variation in performance by focusing is small, and the imaging lens 4 has superior imaging performance.

### Numerical Example 5

[Table 21] illustrates basic lens data of the numerical example 5 in which specific numerical values are applied to the imaging lens 5 illustrated in FIG. 5. Moreover, [Table 22] illustrates values of coefficients in the aspherical surface. Further, [Table 23] illustrates values of the focal length f, the F-number (Fno), and the half angle of view ω of the entire optical system upon infinity focusing.

Furthermore, [Table 24] illustrates values of variable surface separations. In the numerical example 5, values of surface separations D11 and D15 vary upon focusing. Moreover, for reference, [Table 24] illustrates a value of a back focus as D22.

Further, [Table 25] illustrates a start surface of lens surfaces in each group and a value of a focal length of each group.

In the imaging lens 5 according to the numerical example 5, the first lens group GR1 includes a biconvex lens (the positive lens L11), a cemented lens in which a biconvex lens (the first positive lens Lp1) using an aspherical surface on the object side and a biconcave lens (the first negative lens Ln1) are cemented together, and a cemented lens in which a biconcave lens (the second negative lens Ln2) and a biconvex lens (the second positive lens Lp2) are cemented together, and a biconvex lens (the third positive lens Lp3) in order from the object side to the image plane side.

The second lens group GR2 includes a biconcave lens (the negative lens L21) and a biconvex lens (the positive lens L22) in order from the object side to the image plane side.

The third lens group GR3 includes the biconvex lens L31, a cemented lens in which the biconvex lens L32 and the biconcave lens L33 are cemented together, and the negative meniscus lens 134 using an aspherical surface on the image plane side and having a concave surface facing the object side in order from the object side to the image plane side.

TABLE 21
Example 5

| Surface No | Ri | Di | ndi | νdi |
|---|---|---|---|---|
| 1 | 9999.000 | 3.870 | 1.72341 | 37.9 |
| 2 | −120.556 | 2.000 | | |
| 3 (ASP) | 142.653 | 3.724 | 1.85134 | 40.1 |
| 4 | −172.760 | 1.800 | 1.51679 | 64.1 |
| 5 | 29.115 | 13.770 | | |
| 6 | −81.778 | 2.958 | 1.71735 | 29.5 |
| 7 | 52.630 | 8.616 | 1.72916 | 54.6 |
| 8 | −63.028 | 0.600 | | |
| 9 (STO) | ∞ | 3.011 | | |
| 10 | 81.349 | 8.851 | 1.59282 | 68.6 |
| 11 | −53.235 | (D11) | | |
| 12 | −230.455 | 1.800 | 2.0007 | 26.9 |
| 13 | 44.039 | 7.563 | | |
| 14 | 105.184 | 3.329 | 2.10419 | 17 |
| 15 | −248.290 | (D15) | | |
| 16 | 123.240 | 4.901 | 1.80419 | 46.5 |
| 17 | −64.073 | 0.500 | | |
| 18 | 57.294 | 11.130 | 1.80419 | 46.5 |
| 19 | −36.568 | 1.932 | 1.80518 | 25.4 |
| 20 | 32.652 | 10.020 | | |
| 21 | −37.722 | 1.800 | 1.58312 | 59.3 |
| 22 (ASP) | −93.289 | (D22) | | |

TABLE 22
Example 5

| Surface No | K | A4 | A6 |
|---|---|---|---|
| 3 | 0.0000E+00 | −4.2293E−06 | −9.4507E−10 |
| 22 | 0.0000E+00 | 6.8373E−06 | 4.0194E−09 |
| Surface No | A8 | A10 | A12 |
| 3 | −3.2900E−14 | 3.4400E−16 | 0.0000E+00 |
| 22 | 1.3683E−11 | 5.2980E−15 | 0.0000E+00 |

TABLE 23
Example 5

| | |
|---|---|
| f | 50.30 |
| Fno | 1.45 |
| ω | 23.03 |

TABLE 24
Example 5

| | | | |
|---|---|---|---|
| β | 0.00 | 0.03 | 0.15 |
| D11 | 2.515 | 4.587 | 12.515 |
| D15 | 12.000 | 9.928 | 2.000 |
| D22 | 15.506 | 15.506 | 15.506 |

TABLE 25
Example 5

| | Start Surface | Focal Length |
|---|---|---|
| GR1 | 1 | 50.097 |
| GR2 | 12 | −111.837 |
| GR3 | 16 | 114.741 |

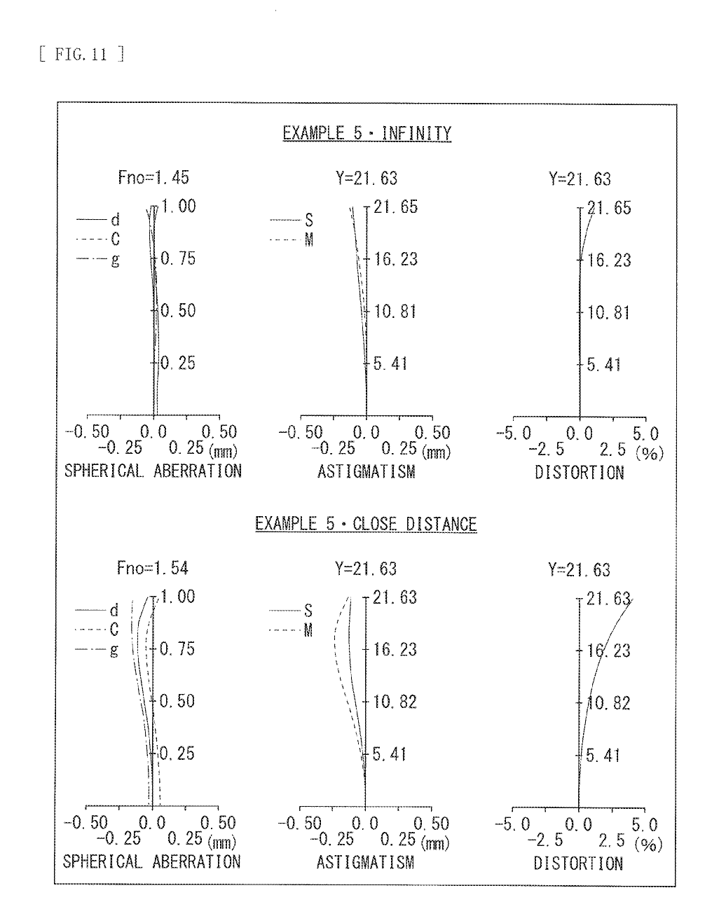

An upper section in FIG. 11 illustrates longitudinal aberrations in an infinity focusing state in the numerical example 5. A lower section in FIG. 11 illustrates longitudinal aberrations in a close-distance focusing state in the numerical example 5.

As can be seen from respective aberration diagrams, it is clear that in the imaging lens 5 according to the numerical example 5, in the infinity focusing state and the close-distance focusing state, respective aberrations are favorably corrected, variation in performance by focusing is small, and the imaging lens 5 has superior imaging performance.

### Numerical Example 6

[Table 26] illustrates basic lens data of the numerical example 6 in which specific numerical values are applied to the imaging lens 6 illustrated in FIG. 6. Moreover, [Table 27] illustrates values of coefficients in the aspherical surface. Further, [Table 28] illustrates values of the focal length f, the F-number (Fno), and the half angle of view ω of the entire optical system upon infinity focusing.

Furthermore, [Table 29] illustrates values of variable surface separations. In the numerical example 6, values of surface separations D11 and D15 vary upon focusing. Moreover, for reference, [Table 29] illustrates a value of a back focus as D22.

Further, [Table 30] illustrates a start surface of lens surfaces in each group and a value of a focal length of each group.

In the imaging lens 6 according to the numerical example 6, the first lens group GR1 includes a biconvex lens (the positive lens L11), a cemented lens in which a biconvex lens (the first positive lens Lp1) using an aspherical surface on the object side and a biconcave lens (the first negative lens are cemented together, a cemented lens in which a biconcave lens (the second negative lens Ln2) and a biconvex lens (the second positive lens Lp2) are cemented together, and a biconvex lens (the third positive lens Lp3) in order from the object side to the image plane side.

The second lens group GR2 includes a biconcave lens (the negative lens L21) and a biconvex lens (the positive lens L22) in order from the object side to the image plane side.

The third lens group GR3 includes the biconvex lens L31, a cemented lens in which the biconvex lens L32 and the biconcave lens 133 are cemented together, and the negative meniscus lens L34 using an aspherical surface on the image plane side and having a concave surface facing the object side in order from the object side to the image plane side.

TABLE 26
Example 6

| Surface No | Ri | Di | ndi | νdi |
|---|---|---|---|---|
| 1 | 99999.000 | 4.736 | 1.72341 | 37.9 |
| 2 | −200.766 | 8.631 | | |
| 3 (ASP) | 312.926 | 2.841 | 1.85134 | 40.1 |
| 4 | −754.681 | 1.800 | 1.51679 | 64.1 |
| 5 | 50.899 | 26.470 | | |
| 6 | −433.749 | 6.000 | 1.71735 | 29.5 |
| 7 | 80.688 | 15.000 | 1.72916 | 54.6 |
| 8 | −132.311 | 6.121 | | |
| 9 (STO) | ∞ | 1.000 | | |
| 10 | 218.081 | 10.830 | 1.59282 | 68.6 |
| 11 | −81.453 | (D11) | | |
| 12 | −594.039 | 1.800 | 1.93889 | 28.1 |
| 13 | 75.336 | 19.430 | | |
| 14 | 181.463 | 4.352 | 2.10419 | 17 |
| 15 | −1007.000 | (D15) | | |
| 16 | 120.640 | 9.500 | 1.80419 | 46.5 |
| 17 | −161.704 | 2.419 | | |
| 18 | 99.396 | 18.990 | 1.80419 | 46.5 |
| 19 | −61.259 | 3.500 | 1.80518 | 25.4 |
| 20 | 48.066 | 17.660 | | |
| 21 | −54.888 | 3.060 | 1.58312 | 59.3 |
| 22 (ASP) | −86.857 | (D22) | | |

TABLE 27
Example 6

| Surface No | K | A4 | A6 |
|---|---|---|---|
| 3 | 0.0000E+00 | −1.0408E−06 | −7.4170E−11 |
| 22 | 0.0000E+00 | 1.9061E−06 | −3.1775E−10 |
| Surface No | A8 | A10 | A12 |
| 3 | −1.4100E−14 | 8.0000E−18 | 0.0000E+00 |
| | 1.6981E−12 | −3.3800E−16 | 0.0000E+00 |

TABLE 28
Example 6

| | |
|---|---|
| f | 82.55 |
| Fno | 1.45 |
| ω | 23.61 |

TABLE 29
Example 6

| | | | |
|---|---|---|---|
| β | 0.00 | 0.03 | 0.15 |
| D11 | 2.000 | 5.439 | 17.915 |
| D15 | 17.915 | 14.477 | 2.000 |
| D22 | 25.360 | 25.360 | 25.360 |

TABLE 30
Example 6

| | Start Surface | Focal Length |
|---|---|---|
| GR1 | 1 | 83.279 |
| GR2 | 12 | −205.425 |
| GR3 | 16 | 199.286 |

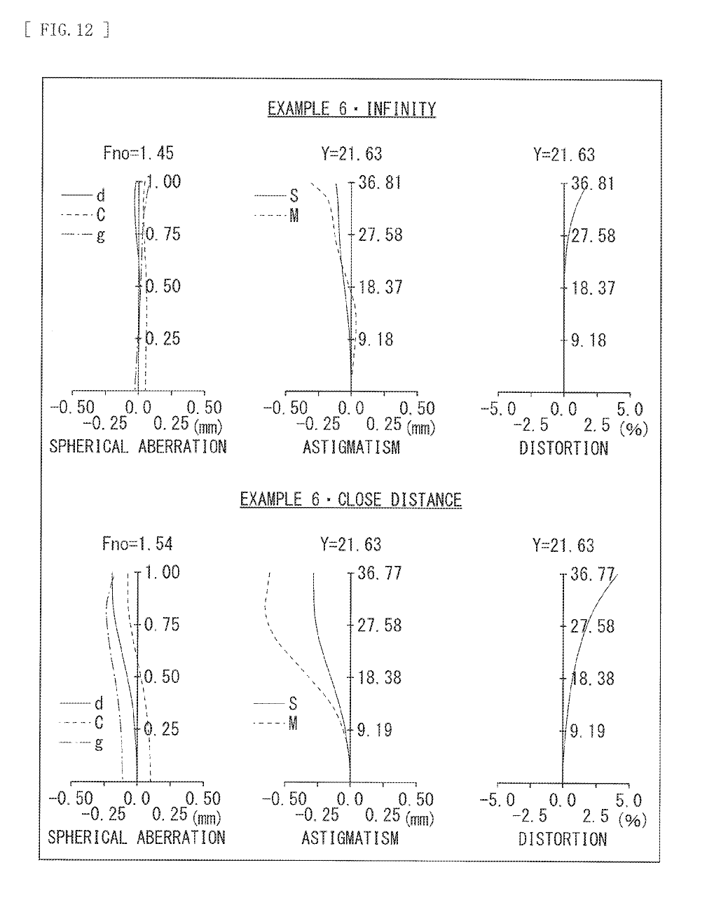

An upper section in FIG. 12 illustrates longitudinal aberrations in an infinity focusing state in the numerical example 6. A lower section in FIG. 10 illustrates longitudinal aberrations in a close-distance focusing state in the numerical example 6.

As can be seen from respective aberration diagrams, it is clear that in the imaging lens 6 according to the numerical example 6, in the infinity focusing state and the close-distance focusing state, respective aberrations are favorably corrected, variation in performance by focusing is small, and the imaging lens 6 has superior imaging performance.

### Other Numerical Data of Respective Examples

[Table 31] illustrates a summary of values related to the above-described respective conditional expressions for the respective numerical examples. As can be seen from [Table 31], in the respective conditional expressions, the values in the respective numerical examples are within the ranges of the numerical values.

TABLE 31

| | | Example | | | | | |
|---|---|---|---|---|---|---|---|
| Conditional Expression | | 1 | 2 | 3 | 4 | 5 | 6 |
| (1) | 1.75 < nn < 2.20 | 1.804 | 1.995 | 1.835 | 1.883 | 2.001 | 1.939 |
| (2) | 1.70 < np < 2.20 | 1.847 | 1.946 | 1.855 | 1.923 | 2.104 | 2.104 |
| (3) | 0 < D2a/f < 0.40 | 0.20 | 0.11 | 0.06 | 0.08 | 0.15 | 0.24 |
| (4) | 0.05 < D1a/D1 < 0.50 | 0.15 | 0.18 | 0.15 | 0.11 | 0.28 | 0.32 |
| (5) | −1.2 < (Rp1 + Rp2)/(Rp1 − Rp2) < 0.2 | −0.09 | −0.17 | −0.95 | −0.04 | −0.40 | −0.69 |
| (6) | −3.0 < f2/f < −1.5 | −2.04 | −2.22 | −2.24 | −1.90 | −2.21 | −2.48 |
| | D2a | 10.29 | 5.45 | 3.00 | 4.13 | 7.56 | 19.44 |
| | f | 51.53 | 50.29 | 51.54 | 51.54 | 50.30 | 82.55 |
| | D1a | 7.82 | 8.84 | 8.14 | 5.73 | 13.78 | 26.47 |
| | D1 | 51.20 | 48.50 | 52.86 | 54.26 | 49.21 | 83.43 |
| | Rp1 | 124.63 | 105.88 | 86.29 | 174.32 | 105.18 | 181.46 |
| | Rp2 | −149.58 | −150.78 | −3731.42 | −188.50 | −248.29 | −1007.01 |
| | f2 | −105.22 | −111.67 | −115.48 | −97.79 | −111.36 | −204.40 |

### 5. OTHER EMBODIMENTS

The technology by the present disclosure is not limited to the description of the embodiments and the examples described above, and may be variously modified.

For example, shapes of the respective components and the numerical values in the respective numerical examples described above are mere specific examples to embody the present technology and the technical range of the present technology should not be limitedly construed based thereon.

Further, in the embodiments and the examples described above, description has been given of a configuration substantially including three lens groups; however, a configuration may be employed in which a lens that has substantially no refractive power is further provided.

Moreover, for example, the present technology may have the following configurations.

[1]

An imaging lens, including:

a first lens group having positive refractive power;

a second lens group having negative refractive power; and

a third lens group having positive refractive power, the first lens group, the second lens group, and the third lens group being provided in order from an object side to an image plane side, in which

only the second lens group travels in an optical axis direction upon focusing, and

the second lens group includes a negative lens and a positive lens in order from the object side to the image plane side with an air spacing in between, and satisfies the following conditional expression,

1.75<nn<2.20 (1)

where nn is a refractive index, at d-line, of the negative lens in the second lens group.

[2]

The imaging lens according to [1], in which the following conditional expression is satisfied,

1.70<np<2.20 (2)

where np is a refractive index, at d-line, of the positive lens in the second lens group.

[3]

The imaging lens according to [1] or [2], in which the following conditional expression is satisfied,

0<D2a/f<0.40 (3)

where D2a is the air spacing between the negative lens and the positive lens in the second lens group, and

f is a focal length of an entire optical system on infinity focusing.

[4]

The imaging lens according to any one of [1] to [3], in which

the first lens group has a surface having a concave surface facing the image plane side and a surface having a concave surface facing the object side,

a longest air spacing in the first lens group is an air spacing between the surface having the concave surface facing the image plane side and the surface having the concave surface facing the object side, and

the following conditional expression is satisfied,

0.05<D1a/D1<0.50 (4)

where D1a is the longest air spacing in the first lens group, and

D1 is a distance from a surface on a most object side in the first lens group to a surface on a most image plane side in the first lens group.

[5]

The imaging lens according to any one of [1] to [4], in which the following conditional expression is satisfied,

−1.2<(Rp1+Rp2)/(Rp1−Rp2)<0.2 (5)

where Rp1 is a radius of curvature of a surface on the object side of the positive lens in the second lens group, and

Rp2 is a radius of curvature of a surface on the image plane side of the positive lens in the second lens group.

[6]

The imaging lens according to any one of [1] to [5], in which the following conditional expression is satisfied,

−3.0<f2/f<−1.50 (6)

where f is a focal length of an entire optical system upon infinity focusing, and

f2 is a focal length of the second lens group.

[7]

The imaging lens according to any one of [1] to [6], in which the first lens group includes:

a positive lens located on a most object side, and

at least two negative lens and one positive lens located closer to the image plane side than the positive lens located on the most object side.

[8]

The imaging lens according to any one of [1] to [7], in which

the first lens group includes a partial lens group having positive refractive power, and

the partial lens group includes a first positive lens, a first negative lens, a second negative lens, a second positive lens, and a third positive lens in order from the object side to the image plane side.

[9]

The imaging lens according to [8], in which in the partial lens group,

a first cemented lens in which the first positive lens and the first negative lens are cemented together is configured, and

a second cemented lens in which the second negative lens and the second positive lens are cemented together is configured.

[10]

The imaging lens according to any one of [1] to [9] further including a lens having substantially no refractive power.

[11]

An imaging apparatus provided with an imaging lens and an imaging device that outputs an imaging signal corresponding to an optical image formed by the imaging lens, the imaging lens including:

a first lens group having positive refractive power;

a second lens group having negative refractive power; and

a third lens group having positive refractive power, the first lens group, the second lens group, and the third lens group being provided in order from an object side to an image plane side, in which

only the second lens group travels in an optical axis direction upon focusing, and

the second lens group includes a negative lens and a positive lens in order from the object side to the image plane side with an air spacing in between, and satisfies the following conditional expression,

1.75<nn<2.20 (1)

where nn is a refractive index, at d-line, of the negative lens in the second lens group.

[12]

The imaging apparatus according to [11] further including a lens having substantially no refractive power.

This application claims the benefit of Japanese Priority Patent Application JP 016-024597 filed with the Japan Patent Office on Feb. 2, 2016, the entire contents of which are incorporated herein by reference.

It should be understood by those skilled in the art that various modifications, combinations, sub-combinations and alterations may occur depending on design requirements and other factors insofar as they are within the scope of the appended claims or the equivalents thereof.

1. An imaging lens, comprising:
a first lens group having positive refractive power;
a second lens group having negative refractive power; and
a third lens group having positive refractive power, the first lens group, the second lens group, and the third lens group being provided in order from an object side to an image plane side, wherein
only the second lens group travels in an optical axis direction upon focusing, and
the second lens group includes a negative lens and a positive lens in order from the object side to the image plane side with an air spacing in between, and satisfies the following conditional expression,
1.75<nn<2.20 (1)
where nn is a refractive index, at d-line, of the negative lens in the second lens group.

2. The imaging lens according to claim 1, wherein the following conditional expression is satisfied,
1.70<np<2.20 (2)
where np is a refractive index, at d-line, of the positive lens in the second lens group.

3. The imaging lens according to claim 1, wherein the following conditional expression is satisfied,
0<D2a/f<0.40 (3)
where D2a is the air spacing between the negative lens and the positive lens in the second lens group, and
f is a focal length of an entire optical system upon infinity focusing.

4. The imaging lens according to claim 1, wherein
the first lens group has a surface having a concave surface facing the image plane side and a surface having a concave surface facing the object side,
a longest air spacing in the first lens group is an air spacing between the surface having the concave surface facing the image plane side and the surface having the concave surface facing the object side, and
the following conditional expression is satisfied,
0.05<D1a/D1<0.50 (4)
where D1a is the longest air spacing in the first lens group, and
D1 is a distance from a surface on a most object side in the first lens group to a surface on a most image plane side in the first lens group.

5. The imaging lens according to claim 1, wherein the following conditional expression is satisfied,
−1.2<(Rp1+Rp2)/(Rp1−Rp2)<0.2 (5)
where Rp1 is a radius of curvature of a surface on the object side of the positive lens in the second lens group, and
Rp2 is a radius of curvature of a surface on the image plane side of the positive lens in the second lens group.

6. The imaging lens according to claim 1, wherein the following conditional expression is satisfied,
−3.0<f2/f<−1.50 (6)
where f is a focal length of an entire optical system upon infinity focusing, and
f2 is a focal length of the second lens group.

7. The imaging lens according to claim 1, wherein the first lens group includes:
a positive lens located on a most object side, and
at least two negative lens and one positive lens located closer to the image plane side than the positive lens located on the most object side.

8. The imaging lens according to claim 1, wherein
the first lens group includes a partial lens group having positive refractive power, and
the partial lens group includes a first positive lens, a first negative lens, a second negative lens, a second positive lens, and a third positive lens in order from the object side to the image plane side.

9. The imaging lens according to claim 8, wherein in the partial lens group,
a first cemented lens in which the first positive lens and the first negative lens are cemented together is configured, and
a second cemented lens in which the second negative lens and the second positive lens are cemented together is configured.

10. An imaging apparatus provided with an imaging lens and an imaging device that outputs an imaging signal corresponding to an optical image formed by the imaging lens, the imaging lens comprising:
a first lens group having positive refractive power;
a second lens group having negative refractive power; and
a third lens group having positive refractive power, the first lens group, the second lens group, and the third lens group being provided in order from an object side to an image plane side, wherein
only the second lens group travels in an optical axis direction upon focusing, and
the second lens group includes a negative lens and a positive lens in order from the object side to the image plane side with an air spacing in between, and satisfies the following conditional expression,
1.75<nn<2.20 (1)
where nn is a refractive index, at d-line, of the negative lens in the second lens group.
